(19) United States
(12) Patent Application Publication
(10) Pub. No.: US 2005/0241436 A1
(43) Pub. Date: Nov. 3, 2005

(54) Cover for housing

(76) Inventor: Dirk-Olaf LEIMANN, Edegem (BE)

Correspondence Address: YOUNG & THOMPSON, 745 SOUTH 23RD STREET, 2ND FLOOR, ARLINGTON, VA, 22202, US

(21) Appl. No.: 10/498,371

(22) PCT Filed: Dec. 5, 2002
(86) PCT No.: PCT/IB02/05155

§ 371 Date: Jan. 24, 2005

(30) Foreign Application Priority Data
Dec. 12, 2001 (GB) 0129628.4

(51) Int. Cl. F16H 57/02

(52) U.S. Cl. 74/606 R

(57) ABSTRACT

A method of retaining and sealing a cover (1) to a housing (2) of a machine includes applying a fluent adhesive material (4) to one or both of the surfaces of the cover and housing which confront one another when the housing and cover are in an assembled condition, assembling the cover to the housing such that the fluent adhesive material is interposed between the cover and the housing over at least part of their confronting surfaces, applying holding elements (5) to the cover and the housing with the adhesive material interposed therebetween to retain them in their relative positions and then effecting an increase in the mechanical strength of the adhesive material sufficient to retain the cover in position on the housing in normal operation of the machine.

The present invention relates to a method of retaining a cover to a housing. The invention relates particularly but not exclusively to a cover for the housing of an industrial gear unit

Covers are found on the housings of industrial gear units for various reasons including the closure of an opening used in the assembly of the internal components, or the closing of a bearing bore. Additionally covers may offer openings in the housing for, for example, inspection or adjustment of the internal components or to provide for connection of accessories.

Furthermore in gear units which are required to run under lubrication covers are necessary in order to close the housing against the escape of lubricant and the ingress of water or contaminates.

Conventionally in such gear box housings the closure of orifices has involved mechanical means of securing covers such as bolting, screwing, clamping or shrink fitting. Where the cover is round it is possible to utilise internal or external screw threading.

With such conventional closures it has been necessary to provide the mating surfaces on the cover and the housing with either a high degree of surface finish or shape conformity or alternatively to provide gasketing in addition to the mechanical clamping.

In either case the mechanical preparation of mating surfaces or provision of an extra gasket component adds to the time and expense of manufacturing the finished gear unit.

It is an object of the present invention to provide an improved method of retaining a cover to a housing which can mitigate the above disadvantages and provide for easier assembly.

A co-pending PCT patent application filed by this Applicant on the same day as this application provides a different solution to the above mentioned problems.

According to one aspect of the present invention there is provided a method of retaining and sealing a cover to a housing of a machine to cover an aperture in said housing comprising applying a fluent adhesive material to one or both of the surfaces of the cover and housing which confront one another when the housing and cover are in an assembled condition, assembling the cover to the housing such that the fluent adhesive material is interposed between the cover and the housing over at least part of their confronting surfaces, applying holding means to the cover and the housing with the adhesive material interposed therebetween to retain them in their relative positions and then effecting an increase in the mechanical strength of the adhesive material sufficient to retain the cover in position on the housing in normal operation of the machine.

The invention is particularly applicable where the machine is a gear unit and particularly a multi-stage gear unit Such machines contain oil as a lubricant and the invention may retain and seal a cover to the housing of the gear unit either above or below the oil level. Furthermore the housings of such machines are generally of cast metal and the housing surface contacted by the adhesive may be a cast or moulded surface i.e. it is not necessary to provide a machined surface. The invention is applicable to gear units designed for power applications ranging from 0.5 horsepower to 4000 horsepower.

Further aspects of the invention will become apparent from the following description, given by way of example only, of embodiments of the invention in conjunction with the following drawings in which:

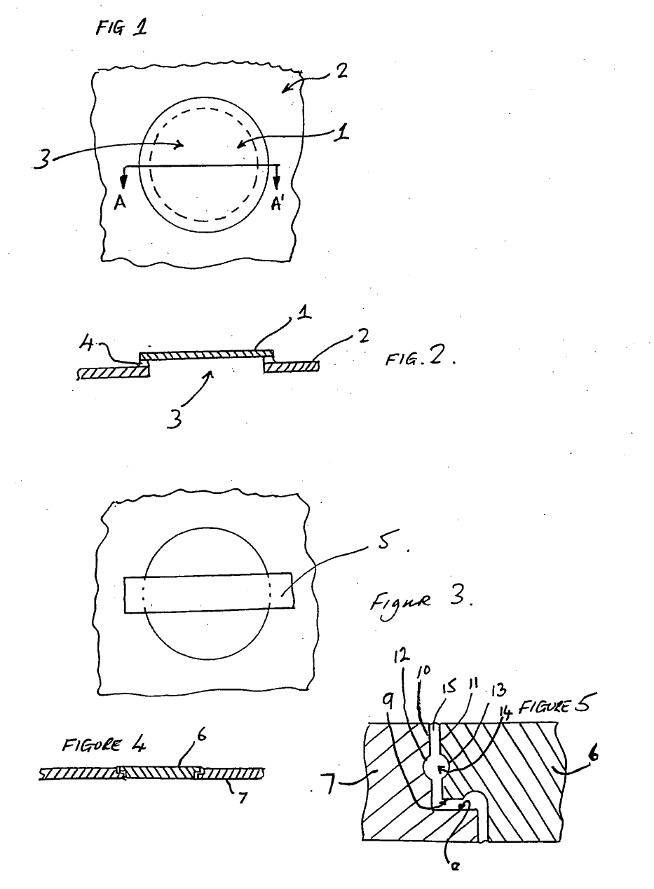

FIG. 1 shows a cover retained in position on the housing of a gear box;

FIG. 2 is a section view taken along A-A¹ in FIG. 1;

FIG. 3 shows external means applied to retain the cover in position during the initial stages of the method; and

FIGS. 4 and 5 show further embodiments of the invention.

FIG. 1 shows a scrap view of a housing 2 of a gearbox having in it an orifice 3 closed by a cover 1 retained on a surface of the housing.

As can be seen in FIG. 2 the cover 1 is retained on the housing 2, to cover a hole 3, by means of an interlayer 4 of adhesive material interposed between the overlapping and confronting surfaces of the cover and housing.

In this embodiment the adhesive material of the layer 4 is a cold curing two component epoxy formulation. In addition to having the property of being able to form a structural bond with the material, such as metal or plastics, of the housing and cover the adhesive is selected to be of a type which increases in strength over time.

In accordance with the method of the invention, shortly after mixing the two components of the epoxy formulation together, resultant mixed material is applied to either the edge region of the circular cover 1 or the edge region of the circular hole 3 or both. The cover is positioned over the orifice 3 and pressed towards the surface of the housing 2. In its freshly mixed condition the epoxy adhesive material flows easily to form a thin layer interposed between the cover and the housing. It also occupies any surface irregularities if either of the confronting surfaces is non-machined, e.g. cast

Subsequently retaining means are applied which in this embodiment comprises a length of adhesive tape 5 extending from the housing on one side of the cover diametrically across the cover to the housing on the other side. The adhesive tape is left in position whilst a chemical reaction in the two part epoxy adhesive ensues to progressively increase the mechanical strength of the adhesive layer 4.

After the elapse of sufficient time to ensure maximum mechanical strength in the adhesive layer 4 the external clamping retaining means 5 is removed leaving the cover 1 retained on the housing 2 and ready for use of the gearbox.

If desired the external retaining means may be left in position or removed as described. Furthermore alternative clamping and retaining means as known in the art may be utilised in the invention.

Whilst the above described embodiment has utilised a cold curing two part epoxy resin adhesive system alternative adhesive systems as known in the art may be utilised in the method of the invention. Such adhesive systems include two-part toughened acrylic adhesives such as LOCTITE ® 341 and single component adhesives such as a room temperature vulcanising silicone adhesive such as LOCTITE ® Product 5910 both of which are marketed by LOCTITE Corporation.

Shown in FIG. 4 is a further embodiment of the invention in which the mating or confronting surfaces of the cover 6 and the housing 7 (shown in section) are the peripheral edges of the cover and the orifice in the housing and the adhesive material is interposed between them. The embodiment shown in FIG. 4 thus makes it possible to provide a cover lying flush with the outer surface of the housing.

Whilst it is possible that both confronting peripheral surfaces may be plain surfaces it is preferred as shown in FIG. 4 that both have confronting shoulders 8, 9 as shown in FIG. 5 to facilitate correct positioning of the cover within the orifice.

In a further refinement of this embodiment shown in FIG. 5 one or both of the peripheral confronting walls 10, 11, which extend generally in the direction of insertion or removal of the cover relative to the housing, may be provided with a peripherally extending groove 12, 13. In consequence there is provided a localised region 14 in which the adhesive layer 15 has an increased volume. Such a configuration additionally facilitates provisions of a mechanical interlock and further improves the eventual security of retention of the cover to the housing.

1. A method of retaining and sealing a cover to a housing of a machine comprising applying a fluent adhesive material to one or both of the surfaces of the cover and housing which confront one another when the housing and cover are in an assembled condition, assembling the cover to the housing such that the fluent adhesive material is interposed between the cover and the housing over at least part of their confronting surfaces, applying holding means to the cover and the housing with the adhesive material interposed therebetween to retain them in their relative positions and then effecting an increase in the mechanical strength of the adhesive material sufficient to retain the cover in position on the housing in normal operation of the machine.

2. A method according to claim 1 wherein the fluent adhesive material is interposed between the cover and the housing over the whole of their confronting surfaces.

3. A method according to claim 1 wherein the holding means comprises the adhesive material itself.

4. A method according to claim 1 wherein the holding means comprises externally applied means.

5. A method according to claim 4 wherein the holding means is subsequently removed.

6. A method according to claim 4 wherein the holding means is subsequently retained.

7. A method according to claim 1 wherein the confronting surfaces of the cover and/or the housing are provided with a groove and the fluent adhesive material fills the groove.

8. A method according to claim 1 wherein the housing is the housing of a gear box.

9. A method according to claim 1 wherein the housing is apertured and the cover is positioned to extend over and seal said aperture.

10. (canceled)

11. A machine with a housing and a cover retained in position relative to the housing by a method according to claim 1.

12. A machine according to claim 11 wherein the machine is a gear unit having a housing to which the cover is secured

13. A machine according to claim 12 wherein said gear unit is of a kind having a power rating of at least 0.5 horsepower.
